(19) United States
(12) Patent Application Publication
(10) Pub. No.: US 2007/0196555 A1
(43) Pub. Date: Aug. 23, 2007

(54) Chili barbecue sauce and method of preparation

(76) Inventor: Barbara Young, Westminster, CA (US)

Correspondence Address: Wesley B. Ames;Ames IP Law, 7031 Los Vientos Serenos, Escondido, CA, 92029, US

(21) Appl. No.: 11/357,294

(22) Filed: Feb. 17, 2006

(51) Int. Cl. A23L 1/40

(52) U.S. Cl. 426/589

(57) ABSTRACT

Barbecue and dipping sauces and methods of preparing such sauces are described.

### RELATED APPLICATIONS

NOT APPLICABLE.

### FIELD OF THE INVENTION

The present invention relates to food products; in particular to barbecue sauces.

### BACKGROUND OF THE INVENTION

The following discussion is provided solely to assist the understanding of the reader, and does not constitute an admission that any of the information discussed or references cited constitute prior art to the present invention.

A large number of different barbecue sauces have been described, and marketed.

For example, Lincoln, U.S. Pat. No. 6,869,634 describes a barbecue sauce “containing a mixture of vinegar, lemon juice, sage, red pepper, paprika, black pepper, white pepper, Worcestershire sauce, steak sauce, margarine, brown sugar, chili powder, garlic salt, onion salt, seasoning salt, meat tenderizer, tomato sauce and ketchup.”

Likewise, Romick, U.S. Pat. No. 6,027,751 describes a method for preparing a temperature-sensitive, shelf-stable, tomato-based food product having a pH of less than 4.6 and containing a tomato base, a preservative, and at least one additional, non-preservative ingredient. In this method “from about 0.000125% to about 0.00125% nisin, and in preferred embodiments from about 0.00025% to about 0.0005% nisin, based on the weight of the food product, is first mixed with the tomato-base. Other ingredients, such as pieces of fresh tomatoes, onions, bell peppers, and the like are then combined with the nisin-containing mixture.” The combination is then heat treated.

Metz et al., U.S. Pat. No. 3,930,030 describes a process for making a barbecue sauce with meat tenderizer and the resulting barbecue sauce. In this product a barbecue sauce having a tenderizing agent is provided. The tenderizing agent is the proteolytic enzyme papain which is substantially free of amylase, and stabilized against loss of proteolytic activity. This tenderizing agent is provided in combination with tomato paste, sugar, gum-oil, salt, spices, garnish preservative agents, vinegar and water.

### SUMMARY OF THE INVENTION

The present invention concerns certain fat-free sauces and methods for preparing such sauces. In particular, the sauces are prepared by mixing a combination of dry ingredients into water, and adding a thickening agent compatible with use in elevated temperature. Such sauces are typically used as barbecue and/or dipping sauces.

Thus, in a first aspect, the invention concerns a method for preparing a barbecue or dipping sauce (preferably a chili barbecue or dipping sauce) that includes mixing water with wet and moist ingredients to form an aqueous mixture or suspension, mixing the dry ingredients into the aqueous mixture and heating and holding at an elevated temperature (e.g., of about 195-200 degrees), and mixing in a gelling or thickening agent, preferably a starch-based gelling or thickening agent such as CLEARJEL® (National Starch and Chemical Corp.). Preferably the sauce is held above 185 degrees F. for at least 2 minutes after addition of the thickener.

In certain embodiments, the sauce ingredients include the components and percentage compositions described for the following aspects, or otherwise described herein (e.g., in the Examples); the sauce is prepared in a batch of at least 100, 200, 300, 400, or 500 gallons.

Thus, in a related aspect, the invention provides a barbecue or dipping sauce (which may be provided by the method described above or otherwise described herein) that includes 58-68% water (referring to added water and not including water contained in other recipe ingredients), 1.1-2.4% vinegar (200 grain or corresponding amount of other strength vinegar, typically with adjustment of the amount of water), 7.5-8.0% tomato paste (or can be replaced with an amount of tomato sauce, or tomato puree that provides an equivalent quantity of tomato solids, typically with adjustment of the amount of water), 6.8-7.2% malt, 3.0-3.5% honey, 4.0-5.5% brown sugar, and 5.2-5.6% Worcestershire sauce, and 3.0-4.0% of thickener (e.g., starch thickener such as CLEARJEL®), along with a desired combination of spices. Optionally the sauce ingredients include 0.6-0.8% of an inosine-5′-monophosphate plus guanosine-5′-monophosphate combination (I+G) or flavoring equivalent amount of another flavor enhancer(s) (e.g., other nucleotides, monosodium glutamate, and/or yeast extract).

In certain embodiments, the sauce contains 60-63% water, either 1.1-1.3 or 2.1-2.3% vinegar, 7.8-7.9% tomato paste, 7.0-7.1% malt, 3.2-3.3% honey, 4.3-5.1% brown sugar, 5.3-5.5% Worcestershire sauce, and 3.2-3.8% starch thickener.

The sauce can also include additional wet or moist ingredients, such as 0.5-2.0% lemon juice, 0.05-0.3% mustard (e.g., yellow mustard), 0.2-0.7% smoke flavoring (e.g., hickory smoke flavoring), 1-6% habanero puree, 1.0-6.0% black bean paste, and/or 1.0-6.0 prune paste. In certain embodiments, in addition to the ingredients above, the sauce includes 0.7-1.2% lemon juice, 0.1-0.2% yellow mustard, 0.4-0.6% hickory smoke flavor. In particular embodiments, the sauce also includes 2-5% habanero puree, and/or 2.0-5.0% black bean paste and 2.0-5.0% prune paste or like amount of a berry or other fruit ingredient.

In certain embodiments, the spice components include a total of 1.5-3.0% dry spice ingredients; the dry spice ingredients include at least 3, 4, 5, 6, 7, or 8 spices selected from the group consisting of chili powder, paprika, onion powder, black pepper, salt, chipotle powder, ketchup spice, cayenne (e.g., 35,000 Scoville unit cayenne), and garlic powder, e.g., 0.3-0.5% chili powder, 0.25-0.4% paprika, 0.15-0.4% onion powder, 0.05-0.20% black pepper, 0.4-1.0% salt (KCl can be substituted in whole or in part with the quantity adjusted to provide equivalent flavor effect), 0.05-0.25% chipotle powder, 0.05-0.15% ketchup spice, 0.05-0.5% cayenne.

The habanero and/or cayenne are used for the spicier recipes, but typically not (or only in small amouts) for milder sauces.

In particular embodiments, the sauce is prepared using a method as described for the above aspect or otherwise described herein.

In particular embodiments, the sauce has a composition as described in any of the Examples herein.

In another related aspect, the invention concerns a bottled barbecue or dipping sauce as described herein, where the bottle has a printed label showing ingredients and nutrition facts, and can also include bar code identifier.

In yet another aspect, the invention concerns a method for preparing a meat (e.g., beef, pork, mutton, chicken, turkey, or fish and the like) product, involving placing a quantity of a barbecue sauce as described herein on a meat (typically a meat intended or being prepared for human consumption). The sauce may be placed on the meat either before, during, or after cooking of heating the meat.

Reference to percentages herein are expressed as weight percentages.

Use of the term “chili” in reference to the present sauces means the inclusion of a pepper or preparation thereof, especially a hot pepper, e.g., having an average rating of at least 1000 Scoville units, or in some cases at least 2000, 5000, 10,000, 20,000, or 30,000 Scoville units.

Additional embodiments will be apparent from the Detailed Description and from the claims.

### DETAILED DESCRIPTION OF THE PREFERRED EMBODIMENTS

Barbecue sauces are popular condiments that are used for a variety of application, including being used on various meats and fish during and/or after cooking. In many cases, such sauces contain substantial quantities of oils or fats, though some fat-free sauces are made.

The present invention provides a set of highly flavorful fat-free barbecue sauces amenable to commercial production, along with an advantageous method for preparing such fat-free barbecue sauces, especially chili barbecue sauces. The sauces are typically prepared using a unique method that involves creation of an aqueous mixture or suspension into which the dry ingredients are mixed. The dry ingredients can advantageously be blended prior to addition to the aqueous mixture. The mixture is performed and/or held at elevated temperature, but preferably the elevated temperature is moderate, only being about 180-220 degrees Fahrenheit, e.g., 195-200 degrees F. For example, the aqueous mixture can be made or placed in a heat-jacketed blending kettle.

The dry ingredients (e.g., as a powdered blend or blends) can be added to the aqueous mixture (e.g., with moderate agitation). The mixture can then be heated to about 200 degrees F., and held for a period of time to allow soluble ingredients to dissolve and for soluble compounds from other ingredients to enter the solution. Such period of time can advantageously be held at the elevated temperature for about 10-30, preferably 15-25, or 18-22 minutes.

The mixture or suspension is thickened to a desired thickness, e.g., using a starch-type thickener such as ClearJel. The thickener, e.g., starch thickener, is added to the mixture containing the other ingredients, typically following the hold interval. Such starch thickener is preferably added as an aqueous suspension, e.g., using about 10% of the total added water for the sauce recipe. For such starch thickeners, the sauce is brought above, or held above about 185 degrees F. for about 2 minutes.

Following thickening, the sauce can be hot-filled into glass bottles, or other containers suitable for packaging hot viscous liquids that have a pH of about 3.8-4.3.

In advantageous preparations, the sauces include about 60% (e.g., 55-68%, or 60-64%, 57-60%, 64-68% water), vinegar (e.g., 1-3%, 1.0-1.4%, or 2.0-2.4% (200 grain or equivalent amount of a different strength)), tomato paste (e.g., 7-8%, or a corresponding amount of tomato sauce can be used with corresponding adjustment in amount of water), malt (e.g., 6.8-7.2 or 7.0-7.1% diastatic malt), honey (e.g., 3.0-3.5% or 3.2-3.3%), brown sugar (e.g., 4.0-5.5% or 4.4-5.0%), Worcestershire sauce (5.2-5.6% or 5.3-5.5%), and thickener (e.g., 3.0-4.0% or 3.2-3.8%, for example a starch thickener such as CLEARJEL®), along with a desired combination of spices (e.g., 1-3%).

The sauce can also include additional wet or moist ingredients, such as lemon juice (e.g., 0.5-2.0% or 0.85-1.0%), mustard (e.g., 0.05-0.3% or 0.1-0.2% preferably yellow mustard), smoke flavoring (e.g., 0.2-0.7% or 0.4-0.5%, for example liquid hickory smoke flavoring).

In some sauces other components are used, for example, habanero puree (e.g., 1.0-6.0% or 2.0-4.0%), black bean paste (e.g., 1.0-6.0% or 2.0-5.0%), and/or prune paste (e.g., 1.0-6.0 or 2.0-5.0%; other fruit paste such as berry may also be used).

In certain embodiments, the spice components include a total of 1.5-3.0% dry spice ingredients selected to give a desired flavor profile. For example, the spice ingredients can include at least 3, 4, 5, 6, 7, or 8 of the following spices: chili powder, paprika, onion powder, black pepper, salt, chipotle powder, ketchup spice, cayenne (e.g., 35,000 Scoville unit cayenne), salt, and garlic powder, e.g., 0.20-0.60% or 0.40-0.50% chili powder, 0.25-0.50% or 0.30-0.40% paprika, 0.15-0.40% or 0.20-0.30% onion powder, 0.05-0.30% or 0.10-0.20% black pepper, 0.4-1.0% or 0.60-0.80% salt (KCl can be substituted in whole or in part with the quantity adjusted to provide equivalent flavor effect), 0.03-0.25% or 0.05-0.15% chipotle powder, 0.03-0.15% or 0.05-0.10 ketchup spice, 0.03-0.5% or 0.05-0.2% cayenne, 0.03-0.20% or 0.05-0.10% garlic powder (garlic powder can be substituted with garlic puree, e.g., with corresponding weight adjustment).

The selection of spices can be as shown in any of the Examples.

In many cases, the sauce has a pH of about 3.8-4.3, or 3.9-4.1. If the initial sauce preparation does not have the desired acidity, additional vinegar may be added to reduce the pH.

Ingredients can be obtained from any of a variety of commercially available sources. Exemplary sources and/or brands include Fleischman's (vinegar), Morningstar (tomato paste), Premier Malt (DiaMalt; Malt), Elite (chili powder, paprika, onion powder, black pepper, salt, chipotle powder, cayenne), Spice

Products (ketchup spice), Vita_Pakt (lemon juice), C&H (brown sugar), Moorehouse (yellow mustard-prep), Red Arrow Charsol (hickory smoke), National Starch & Chemical (ClearJel), Anjimoto (I+G), Heiden's (Worcestershire sauce), Haliburton (habanero puree).

As recognized by those skilled in food preparation, a number of ingredients can be substituted. For example, vinegar 200 grain can be substituted with a vinegar having a different acetic acid concentration (e.g., 100 grain); if needed the quantity can be adjusted to provide equivalent acetic acid (adjustment to the amount of added water may also be performed). Similarly, at least some of the vinegar may be replaced with lemon juice (or the converse). While such replacement is not an exact equivalent, the exchange substitutes one acid source for another (exchanging acetic acid and primarily ascorbic acid).

Similarly, at least some of the honey and brown sugar may be exchanged, though with some flavor changes. The amounts can be adjusted to provide equivalent sweetness. Similarly, at least some of the brown sugar and/or honey can be substituted with a white sugar or other heat-stable sweetener.

Further, a paste, puree, of sauce of a vegetable or fruit can be substituted with one of the other forms, with adjustment of quantity as needed to provide equivalent flavor and/or solids content. Adjustment of the amount of added water may also be needed to compensate for the differing water content of the paste or other form.

### EXAMPLES

### Example 1

### Exemplary Preparation Method

Exemplary barbecue or dipping sauces can be prepared generally using the following preparation method

All dry ingredients are typically but not necessarily blended together to form a clump-free powder.

Water (approx. 90% of total) and wet or moist ingredients (e.g., water, vinegar, tomato paste, honey, lemon juice, yellow mustard, hickory smoke, and Worcestershire sauce, along with hanabero puree, black bean paste, and/or prune paste when used, are mixed to form an aqueous suspension or solution in a heat-jacketed blending kettle.

The dry ingredient mixture is added with stirring to the aqueous mixture, heated to 195-200 degrees F., and held for 20 minutes.

Starch gelling agent or thickener (e.g., ClearJel) is mixed with the remaining water (approximately 20% of the total water) and added to the heated mixture. Following, addition of the starch solution, the mixture is brought above 185 degrees F. for 2 minutes.

The resulting sauces are then preferably hot-filled into desired containers, e.g., bottles.

Exemplary barbecue sauces can be prepared using this general preparation, e.g., using the recipes described below. In some cases, the total percentages may differ slightly from 100% due to rounding of the percentages. Where included, I+G refers to a mixture of inosine-5′monophosphate and guanosine-5′-monophosphate (e.g., an equal mixture), which is optional in the recipes. Though some individuals prefer to avoid monosodium glutamate (MSG), such flavor enhancer can be used in combination with one or more nucleotide flavor enhancers or as an alternative.

### Example 2

### Exemplary Recipe 1

A chili barbecue or dipping sauce can be prepared using the following ingredients:

| Ingredient | Weight % |
|---|---|
| Water | 62.09 |
| Vinegar (200 grain) | 1.76 |
| Tomato paste | 7.93 |
| Malt | 7.12 |
| Honey | 3.34 |
| Chili powder | 0.38 |
| Paprika | 0.27 |
| Onion powder | 0.32 |
| Black pepper | 0.12 |
| Salt | 0.70 |
| Chipotle powder | 0.05 |
| Ketchup spice | 0.05 |
| Lemon juice | 0.92 |
| Brown sugar | 4.96 |
| Yellow mustard | 0.16 |
| Hickory smoke | 0.49 |
| ClearJel | 3.34 |
| I + G | 0.70 |
| Worcestershire sauce | 5.30 |

### Example 3

### Exemplary Recipe 2

A chili barbecue or dipping sauce can be prepared using the following ingredients:

| Ingredient | Weight % |
|---|---|
| Water | 63.10 |
| Vinegar (200 grain) | 2.16 |
| Tomato paste | 7.83 |
| Malt | 7.02 |
| Honey | 3.24 |
| Chili powder | 0.32 |
| Paprika | 0.32 |
| Onion powder | 0.22 |
| Black pepper | 0.12 |
| Salt | 0.70 |
| Chipotle powder | 0.05 |
| Ketchup spice | 0.05 |
| Lemon juice | 0.95 |
| Brown sugar | 4.86 |
| Yellow mustard | 0.22 |
| Hickory smoke | 0.40 |
| ClearJel | 3.35 |
| I + G | 0.70 |
| Worcestershire sauce | 4.39 |

### Example 4

### Exemplary Recipe 3

A chili barbecue or dipping sauce can be prepared using the following ingredients:

| Ingredient | Weight % |
|---|---|
| Water | 62.09 |
| Vinegar (200 grain) | 2.16 |
| Tomato paste | 7.83 |
| Malt | 7.02 |
| Honey | 3.24 |
| Chili powder | 0.38 |
| Paprika | 0.32 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 4.86 |
| Yellow mustard | 0.16 |
| Hickory smoke | 0.49 |
| ClearJel | 3.24 |
| I + G | 0.70 |
| Worcestershire sauce | 5.40 |

### Example 5

### Exemplary Recipe 4

A chili barbecue or dipping sauce can be prepared using the following ingredients:

| Ingredient | Weight % |
|---|---|
| Water | 62.59 |
| Vinegar (200 grain) | 1.81 |
| Tomato paste | 7.78 |
| Malt | 7.02 |
| Honey | 2.24 |
| Chili powder | 0.38 |
| Paprika | 0.37 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 5.06 |
| Yellow mustard | 0.16 |
| Hickory smoke | 0.55 |
| ClearJel | 3.49 |
| I + G | 0.70 |
| Worcestershire sauce | 5.70 |

### Example 6

### Exemplary Recipe 5

A chili barbecue or dipping sauce can be prepared using the following ingredients:

| Ingredient | Weight % |
|---|---|
| Water | 62.09 |
| Vinegar (200 grain) | 2.21 |
| Tomato paste | 7.88 |
| Malt | 7.12 |
| Honey | 3.54 |
| Chili powder | 0.38 |
| Paprika | 0.32 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 4.56 |
| Yellow mustard | 0.16 |
| Hickory smoke | 0.34 |
| ClearJel | 3.29 |
| I + G | 0.65 |
| Worcestershire sauce | 5.30 |

### Example 7

### Exemplary Recipe 6

A chili barbecue or dipping sauce can be prepared using the following ingredients:

| Ingredient | Weight % |
|---|---|
| Water | 62.26 |
| Vinegar (200 grain) | 2.17 |
| Tomato paste | 7.85 |
| Malt | 7.04 |
| Honey | 3.25 |
| Chili powder | 0.38 |
| Paprika | 0.32 |
| Onion powder | 0.27 |
| Black pepper | 0.12 |
| Salt | 0.70 |
| Chipotle powder | 0.11 |
| Lemon juice | 0.92 |
| Brown sugar | 4.60 |
| Yellow mustard | 0.16 |
| Hickory smoke | 0.49 |
| ClearJel | 3.25 |
| I + G | 0.70 |
| Worcestershire sauce | 5.41 |

### Example 8

### Exemplary Recipe 7

A chili barbecue or dipping sauce can be prepared using the following ingredients:

| Ingredient | Weight % |
|---|---|
| Water | 61.96 |
| Vinegar (200 grain) | 2.11 |
| Tomato paste | 7.95 |
| Malt | 7.14 |
| Honey | 3.15 |
| Chili powder | 0.32 |
| Paprika | 0.38 |
| Onion powder | 0.27 |
| Black pepper | 0.12 |
| Salt | 0.70 |
| Chipotle powder | 0.11 |
| Lemon juice | 0.98 |
| Brown sugar | 4.80 |
| Yellow mustard | 0.16 |
| Hickory smoke | 0.49 |
| ClearJel | 3.31 |
| I + G | 0.70 |
| Worcestershire sauce | 5.35 |

### Example 9

### Exemplary Recipe 8

A chili barbecue or dipping sauce can be prepared using the following ingredients:

| Ingredient | Weight % |
|---|---|
| Water | 62.21 |
| Vinegar (200 grain) | 2.17 |
| Tomato paste | 7.80 |
| Malt | 7.09 |
| Honey | 3.19 |
| Chili powder | 0.38 |
| Paprika | 0.38 |
| Onion powder | 0.22 |
| Black pepper | 0.16 |
| Salt | 0.70 |
| Chipotle powder | 0.11 |
| Lemon juice | 0.97 |
| Brown sugar | 4.45 |
| Yellow mustard | 0.24 |
| Hickory smoke | 0.41 |
| ClearJel | 3.26 |
| I + G | 0.70 |
| Worcestershire sauce | 5.40 |

### Example 10

### Exemplary Recipe 9

A chili barbecue or dipping sauce can be prepared using the following ingredients:

| Ingredient | Weight % |
|---|---|
| Water | 66.25 |
| Vinegar (200 grain) | 2.13 |
| Tomato paste | 7.80 |
| Malt | 7.02 |
| Chili powder | 0.48 |
| Paprika | 0.36 |
| Onion powder | 0.31 |
| Black pepper | 0.11 |
| Salt | 0.68 |
| Lemon juice | 0.94 |
| Brown sugar | 4.48 |
| Yellow mustard | 0.21 |
| Hickory smoke | 0.47 |
| Ketchup spice | 0.03 |
| ClearJel | 2.75 |
| I + G | 0.68 |
| Worcestershire sauce | 5.31 |

### Example 11

### Exemplary Recipe 10

A chili barbecue or dipping sauce can be prepared using the following ingredients:

| Ingredient | Weight % |
|---|---|
| Water | 67.29 |
| Vinegar (200 grain) | 2.08 |
| Tomato paste | 7.55 |
| Malt | 6.77 |
| Chili powder | 0.48 |
| Paprika | 0.31 |
| Onion powder | 0.26 |
| Black pepper | 0.11 |
| Salt | 0.68 |
| Lemon juice | 0.89 |
| Brown sugar | 4.43 |
| Yellow mustard | 0.16 |
| Hickory smoke | 0.47 |
| Ketchup spice | 0.03 |
| ClearJel | 2.60 |
| I + G | 0.68 |
| Worcestershire sauce | 5.21 |

### Example 12

### Exemplary Recipe 11

A chili barbecue or dipping sauce can be prepared using the following ingredients:

| Ingredient | Weight % |
|---|---|
| Water | 67.04 |
| Vinegar (200 grain) | 2.28 |
| Tomato paste | 7.85 |
| Malt | 6.87 |
| Chili powder | 0.43 |
| Paprika | 0.31 |
| Onion powder | 0.21 |
| Black pepper | 0.11 |
| Salt | 0.63 |
| Lemon juice | 0.84 |
| Brown sugar | 4.38 |
| Yellow mustard | 0.16 |
| Hickory smoke | 0.42 |
| Ketchup spice | 0.03 |
| ClearJel | 2.60 |
| I + G | 0.68 |
| Worcestershire sauce | 5.16 |

### Example 13

### Exemplary Recipe 12

A chili barbecue or dipping sauce can be prepared using the following ingredients:

| Ingredient | Weight % |
|---|---|
| Water | 60.04 |
| Vinegar (200 grain) | 2.30 |
| Tomato paste | 7.60 |
| Malt | 6.80 |
| Honey | 3.20 |
| Chili powder | 0.35 |
| Paprika | 0.33 |
| Onion powder | 0.22 |
| Black pepper | 0.12 |
| Salt | 0.70 |
| Chipotle powder | 0.05 |
| Ketchup spice | 0.05 |
| Lemon juice | 0.92 |
| Brown sugar | 4.60 |
| Yellow mustard | 0.16 |
| Hickory smoke | 0.40 |
| ClearJel | 3.20 |
| I + G | 0.60 |
| Habanero puree | 3.25 |
| Worcestershire sauce | 5.10 |

### Example 14

### Exemplary Recipe 13

A chili barbecue or dipping sauce can be prepared using the following ingredients:

| Ingredient | Weight % |
|---|---|
| Water | 59.54 |
| Vinegar (200 grain) | 2.20 |
| Tomato paste | 7.80 |
| Malt | 7.00 |
| Honey | 3.30 |
| Chili powder | 0.40 |
| Paprika | 0.33 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 5.00 |
| Yellow mustard | 0.16 |
| Hickory smoke | 0.50 |
| ClearJel | 3.30 |
| I + G | 0.70 |
| Habanero puree | 2.25 |
| Worcestershire sauce | 5.40 |

### Example 15

### Exemplary Recipe 14

A chili barbecue or dipping sauce can be prepared using the following ingredients:

| Ingredient | Weight % |
|---|---|
| Water | 56.56 |
| Vinegar (200 grain) | 2.09 |
| Tomato paste | 7.41 |
| Malt | 6.65 |
| Honey | 3.14 |
| Chili powder | 0.38 |
| Paprika | 0.31 |
| Onion powder | 0.26 |
| Black pepper | 0.11 |
| Salt | 0.66 |
| Chipotle powder | 0.05 |
| Ketchup spice | 0.05 |
| Lemon juice | 0.87 |
| Brown sugar | 4.75 |
| Yellow mustard | 0.15 |
| Hickory smoke | 0.48 |
| ClearJel | 3.14 |
| I + G | 0.66 |
| Habanero puree | 2.14 |
| Worcestershire sauce | 5.13 |
| Prune paste | 2.50 |
| Black bean paste | 2.50 |
| Garlic powder | 0.05 |

### Example 16

### Exemplary Recipe 15

A chili barbecue or dipping sauce can be prepared using the following ingredients:

| Ingredient | Weight % |
|---|---|
| Water | 53.048 |
| Vinegar (200 grain) | 1.20 |
| Tomato paste | 7.83 |
| Malt | 7.02 |
| Honey | 3.24 |
| Chili powder | 0.38 |
| Paprika | 0.32 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 4.86 |
| Yellow mustard | 0.16 |
| Hickory smoke | 0.49 |
| ClearJel | 3.24 |
| Water for starch solutin | 10.00 |
| I + G | 0.70 |
| Worcestershire sauce | 5.40 |

### Example 17

### Exemplary Recipe 16

A chili barbecue or dipping sauce can be prepared using the following ingredients:

| Ingredient | Weight % |
|---|---|
| Water | 53.05 |
| Vinegar (200 grain) | 1.50 |
| Tomato paste | 7.73 |
| Malt | 7.12 |
| Honey | 3.04 |
| Chili powder | 0.38 |
| Paprika | 0.37 |
| Onion powder | 0.27 |
| Black pepper | 0.12 |
| Salt | 0.70 |
| Chipotle powder | 0.05 |
| Ketchup spice | 0.05 |
| Lemon juice | 0.97 |
| Brown sugar | 4.86 |
| Yellow mustard | 0.16 |
| Hickory smoke | 0.49 |
| ClearJel | 3.24 |
| Water for starch solutin | 10.00 |
| I + G | 0.70 |
| Worcestershire sauce | 5.40 |

### Example 18

### Exemplary Recipe 17

A chili barbecue or dipping sauce can be prepared using the following ingredients:

| Ingredient | Weight % |
|---|---|
| Water | 53.10 |
| Vinegar (200 grain) | 1.41 |
| Tomato paste | 7.73 |
| Malt | 7.02 |
| Honey | 3.24 |
| Chili powder | 0.38 |
| Paprika | 0.32 |
| Onion powder | 0.27 |
| Black pepper | 0.12 |
| Salt | 0.75 |
| Chipotle powder | 0.05 |
| Ketchup spice | 0.05 |
| Lemon juice | 0.92 |
| Brown sugar | 4.70 |
| Yellow mustard | 0.21 |
| Hickory smoke | 0.49 |
| ClearJel | 3.29 |
| Water for starch solutin | 10.00 |
| I + G | 0.65 |
| Worcestershire sauce | 5.30 |

### Example 19

### Exemplary Recipe 18

A chili barbecue or dipping sauce can be prepared using the following ingredients:

| Ingredient | Weight % |
|---|---|
| Water | 62.23 |
| Vinegar (200 grain) | 1.30 |
| Tomato paste | 7.95 |
| Malt | 7.14 |
| Honey | 3.35 |
| Chili powder | 0.38 |
| Paprika | 0.32 |
| Onion powder | 0.27 |
| Black pepper | 0.12 |
| Salt | 0.70 |
| Chipotle powder | 0.11 |
| Lemon juice | 0.92 |
| Brown sugar | 4.80 |
| Yellow mustard | 0.16 |
| Hickory smoke | 0.49 |
| ClearJel | 3.45 |
| I + G | 0.70 |
| Worcestershire sauce | 5.61 |

### Example 20

### Exemplary Recipe 19

A chili barbecue or dipping sauce can be prepared using the following ingredients:

| Ingredient | Weight % |
|---|---|
| Water | 63.23 |
| Vinegar (200 grain) | 1.20 |
| Tomato paste | 7.85 |
| Malt | 7.04 |
| Honey | 3.25 |
| Chili powder | 0.38 |
| Paprika | 0.32 |
| Onion powder | 0.27 |
| Black pepper | 0.12 |
| Salt | 0.70 |
| Chipotle powder | 0.11 |
| Lemon juice | 0.92 |
| Brown sugar | 4.60 |
| Yellow mustard | 0.16 |
| Hickory smoke | 0.49 |
| ClearJel | 3.25 |
| I + G | 0.70 |
| Worcestershire sauce | 5.41 |

### Example 21

### Exemplary Recipe 20

A chili barbecue or dipping sauce can be prepared using the following ingredients:

| Ingredient | Weight % |
|---|---|
| Water | 59.15 |
| Vinegar (200 grain) | 2.06 |
| Tomato paste | 7.46 |
| Malt | 6.69 |
| Honey | 3.09 |
| Chili powder | 0.36 |
| Paprika | 0.30 |
| Onion powder | 0.26 |
| Black pepper | 0.11 |
| Salt | 0.66 |
| Chipotle powder | 0.10 |
| Lemon juice | 0.87 |
| Brown sugar | 4.37 |
| Yellow mustard | 0.15 |
| Hickory smoke | 0.47 |
| ClearJel | 3.09 |
| I + G | 0.67 |
| Worcestershire sauce | 5.14 |
| Prune paste | 2.50 |
| Black bean paste | 2.50 |
| Garlic powder | 0.05 |

### Example 22

### Exemplary Recipe 21

A chili barbecue or dipping sauce can be prepared using the following ingredients:

| Ingredient | Weight % |
|---|---|
| Water | 48.14 |
| Vinegar (200 grain) | 1.20 |
| Tomato paste | 7.80 |
| Malt | 7.00 |
| Honey | 3.30 |
| Chili powder | 0.40 |
| Paprika | 0.33 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 5.00 |
| Yellow mustard | 0.16 |
| Hickory smoke | 0.50 |
| ClearJel | 3.75 |
| Water for starch solution | 10.00 |
| I + G | 0.70 |
| Habanero puree | 4.00 |
| Cayenne pepper 35K | 0.20 |
| Worcestershire sauce | 5.40 |

### Example 23

### Exemplary Recipe 22

A chili barbecue or dipping sauce can be prepared using the following ingredients:

| Ingredient | Weight % |
|---|---|
| Water | 48.26 |
| Vinegar (200 grain) | 1.20 |
| Tomato paste | 7.65 |
| Malt | 7.00 |
| Honey | 3.20 |
| Chili powder | 0.40 |
| Paprika | 0.27 |
| Onion powder | 0.22 |
| Black pepper | 0.12 |
| Salt | 0.65 |
| Chipotle powder | 0.05 |
| Ketchup spice | 0.05 |
| Lemon juice | 0.92 |
| Brown sugar | 4.60 |
| Yellow mustard | 0.16 |
| Hickory smoke | 0.45 |
| ClearJel | 3.70 |
| Water for starch solution | 10.00 |
| I + G | 0.65 |
| Habanero puree | 5.00 |
| Cayenne pepper 35K | 0.25 |
| Worcestershire sauce | 5.20 |

### Example 24

### Exemplary Recipe 23

A chili barbecue or dipping sauce can be prepared using the following ingredients:

| Ingredient | Weight % |
|---|---|
| Water | 48.14 |
| Vinegar (200 grain) | 1.20 |
| Tomato paste | 7.80 |
| Malt | 7.00 |
| Honey | 3.20 |
| Chili powder | 0.40 |
| Paprika | 0.33 |
| Onion powder | 0.27 |
| Black pepper | 0.12 |
| Salt | 0.65 |
| Chipotle powder | 0.05 |
| Ketchup spice | 0.05 |
| Lemon juice | 0.92 |
| Brown sugar | 4.90 |
| Yellow mustard | 0.16 |
| Hickory smoke | 0.50 |
| ClearJel | 3.65 |
| Water for starch solution | 10.00 |
| I + G | 0.70 |
| Habanero puree | 4.50 |
| Cayenne pepper 35K | 0.15 |
| Worcestershire sauce | 5.30 |

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the precise proportions of ingredients. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numberical values are provided for embodiments, additional embodiments are described by taking any 2 different values as the endpoints of a range. Such ranges are also within the scope of the described invention.

Thus, additional embodiments are within the scope of the invention and within the following claims.

What is claimed is:

1. A method for preparing a barbecue sauce, comprising
mixing wet and moist ingredients into water to form an aqueous suspension;
stirring dry ingredients into said aqueous suspension to form a flavor mixture and heating and holding said flavor mixture at 180-210 degrees Fahrenheit for 15-30 minutes; and
mixing starch gelling agent solution with the flavor mixture with temperature above 185 degrees Fahrenheit and holding for at least 2 minutes to form a final mixture.

2. The method of claim 1, wherein said aqueous suspension is heated to 195-200 degrees Fahrenheit and said flavor mixture is held at 195-200 degrees Fahrenheit.

3. The method of claim 1, wherein said wet and moist ingredients comprise water, vinegar, tomato paste, honey, Worcestershire sauce, lemon juice, yellow mustard, and liquid hickory smoke flavor.

4. The method of claim 1, wherein said dry ingredients comprise malt, brown sugar, chili powder, paprika, onion powder, black pepper, salt, and chipotle powder.

5. The method of claim 1, wherein said wet and moist ingredients and said dry ingredients comprise
58.0-68.0% water;
1.0-2.5% vinegar;
7.5-8.0% tomato paste;
6.8-7.2% malt;
3.0-3.5% honey;
4.0-5.5% brown sugar;
5.2-5.6% Worcestershire sauce;
3.0-4.0% starch thickener; and
1.0-3.0% of dry spices.

6. The method of claim 5, wherein said dry spices comprise
0.3-0.5% chili powder;
0.25-0.4% paprika;
0.15-0.4% onion powder;
0.05-0.20% black pepper;
0.4-1.0% salt; and
0.05-0.25% chipotle powder.

7. A barbecue or dipping sauce comprising an ingredient set consisting of
58.0-68.0% water;
1.0-2.5% vinegar;
7.5-8.0% tomato paste;
6.8-7.2% malt;
3.0-3.5% honey;
4.0-5.5% brown sugar;
5.2-5.6% Worcestershire sauce;
3.0-4.0% starch thickener; and
1.0-3.0% of dry spices,
wherein said sauce is prepared by the method of claim 1.

8. The sauce of claim 5, wherein said dry spices comprise
0.3-0.5% chili powder;
0.25-0.4% paprika;
0.15-0.4% onion powder;
0.05-0.20% black pepper;
0.4-1.0% salt; and
0.05-0.25% chipotle powder.

9. A barbecue or dipping sauce, wherein said sauce is prepared using an ingredient set comprising:
58.0-68.0% water;
1.0-2.5% vinegar;
7.5-8.0% tomato paste;
6.8-7.2% malt;
3.0-3.5% honey;
4.0-5.5% brown sugar;
5.2-5.6% Worcestershire sauce;
3.0-4.0% starch thickener; and
1.0-3.0 of dry spices.

10. The sauce of claim 9, wherein said dry spices comprise
0.3-0.5% chili powder;
0.25-0.4% paprika;
0.15-0.4% onion powder;
0.05-0.20% black pepper;
0.4-1.0% salt; and
0.05-0.25% chipotle powder.

11. The sauce of claim 10, further comprising 0.6-0.8% of an inosine-5′-monophosphate plus guanosine-5′-monophosphate combination.

12. The sauce of claim 9, further comprising 1-6% habanero puree.

13. The sauce of claim 9, further comprising 1.0-6.0% black bean paste, or 1.0-6.0 prune paste or both.

14. The sauce of claim 9, wherein said sauce is prepared from an ingredient set selected from the group consisting of

| Ingredient | Weight % |
|---|---|
| Water | 62.09 |
| Vinegar (200 grain) | 1.76 |
| Tomato paste | 7.93 |
| Malt | 7.12 |
| Honey | 3.34 |
| Chili powder | 0.38 |
| Paprika | 0.27 |
| Onion powder | 0.32 |
| Black pepper | 0.12 |
| Salt | 0.70 |
| Chipotle powder | 0.05 |
| Ketchup spice | 0.05 |
| Lemon juice | 0.92 |
| Brown sugar | 4.96 |
| Yellow mustard | 0.16 |
| Hickory smoke | 0.49 |
| ClearJel | 3.34 |
| I + G | 0.70 |
| Worcestershire sauce | 5.30; |
| Water | 63.10 |
| Vinegar (200 grain) | 2.16 |
| Tomato paste | 7.83 |
| Malt | 7.02 |
| Honey | 3.24 |
| Chili powder | 0.32 |
| Paprika | 0.32 |
| Onion powder | 0.22 |
| Black pepper | 0.12 |
| Salt | 0.70 |
| Chipotle powder | 0.05 |
| Ketchup spice | 0.05 |
| Lemon juice | 0.95 |
| Brown sugar | 4.86 |
| Yellow mustard | 0.22 |
| Hickory smoke | 0.40 |
| ClearJel | 3.35 |
| I + G | 0.70 |
| Worcestershire sauce | 4.39; |
| Water | 62.09 |
| Vinegar (200 grain) | 2.16 |
| Tomato paste | 7.83 |
| Malt | 7.02 |
| Honey | 3.24 |
| Chili powder | 0.38 |
| Paprika | 0.32 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 4.86 |
| Yellow mustard | 0.16 |
| Hickory smoke | 0.49 |
| ClearJel | 3.24 |
| I + G | 0.70 |
| Worcestershire sauce | 5.40; |
| Water | 62.59 |
| Vinegar (200 grain) | 1.81 |
| Tomato paste | 7.78 |
| Malt | 7.02 |
| Honey | 2.24 |
| Chili powder | 0.38 |
| Paprika | 0.37 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 5.06 |
| Yellow mustard | 0.16 |
| Hickory smoke | 0.55 |
| ClearJel | 3.49 |
| I + G | 0.70 |
| Worcestershire sauce | 5.70; |
| Water | 62.09 |
| Vinegar (200 grain) | 2.21 |
| Tomato paste | 7.88 |
| Malt | 7.12 |
| Honey | 3.54 |
| Chili powder | 0.38 |
| Paprika | 0.32 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 4.56 |
| Yellow mustard | 0.16 |
| Hickory smoke | 0.34 |
| ClearJel | 3.29 |
| I + G | 0.65 |
| Worcestershire sauce | 5.30; |
| Water | 62.26 |
| Vinegar (200 grain) | 2.17 |
| Tomato paste | 7.85 |
| Malt | 7.04 |
| Honey | 3.25 |
| Chili powder | 0.38 |
| Paprika | 0.32 |
| Onion powder | 0.27 |
| Black pepper | 0.12 |
| Salt | 0.70 |
| Chipotle powder | 0.11 |
| Lemon juice | 0.92 |
| Brown sugar | 4.60 |
| Yellow mustard | 0.16 |
| Hickory smoke | 0.49 |
| ClearJel | 3.25 |
| I + G | 0.70 |
| Worcestershire sauce | 5.41; |
| Water | 61.96 |
| Vinegar (200 grain) | 2.11 |
| Tomato paste | 7.95 |
| Malt | 7.14 |
| Honey | 3.15 |
| Chili powder | 0.32 |
| Paprika | 0.38 |
| Onion powder | 0.27 |
| Black pepper | 0.12 |
| Salt | 0.70 |
| Chipotle powder | 0.11 |
| Lemon juice | 0.98 |
| Brown sugar | 4.80 |
| Yellow mustard | 0.16 |
| Hickory smoke | 0.49 |
| ClearJel | 3.31 |
| I + G | 0.70 |
| Worcestershire sauce | 5.35; |
| Water | 62.21 |
| Vinegar (200 grain) | 2.17 |
| Tomato paste | 7.80 |
| Malt | 7.09 |
| Honey | 3.19 |
| Chili powder | 0.38 |
| Paprika | 0.38 |
| Onion powder | 0.22 |
| Black pepper | 0.16 |
| Salt | 0.70 |
| Chipotle powder | 0.11 |
| Lemon juice | 0.97 |
| Brown sugar | 4.45 |
| Yellow mustard | 0.24 |
| Hickory smoke | 0.41 |
| ClearJel | 3.26 |
| I + G | 0.70 |
| Worcestershire sauce | 5.40; |
| Water | 66.25 |
| Vinegar (200 grain) | 2.13 |
| Tomato paste | 7.80 |
| Malt | 7.02 |
| Chili powder | 0.48 |
| Paprika | 0.36 |
| Onion powder | 0.31 |
| Black pepper | 0.11 |
| Salt | 0.68 |
| Lemon juice | 0.94 |
| Brown sugar | 4.48 |
| Yellow mustard | 0.21 |
| Hickory smoke | 0.47 |
| Ketchup spice | 0.03 |
| ClearJel | 2.75 |
| I + G | 0.68 |
| Worcestershire sauce | 5.31; |
| Water | 67.29 |
| Vinegar (200 grain) | 2.08 |
| Tomato paste | 7.55 |
| Malt | 6.77 |
| Chili powder | 0.48 |
| Paprika | 0.31 |
| Onion powder | 0.26 |
| Black pepper | 0.11 |
| Salt | 0.68 |
| Lemon juice | 0.89 |
| Brown sugar | 4.43 |
| Yellow mustard | 0.16 |
| Hickory smoke | 0.47 |
| Ketchup spice | 0.03 |
| ClearJel | 2.60 |
| I + G | 0.68 |
| Worcestershire sauce | 5.21; |
| Water | 67.04 |
| Vinegar (200 grain) | 2.28 |
| Tomato paste | 7.85 |
| Malt | 6.87 |
| Chili powder | 0.43 |
| Paprika | 0.31 |
| Onion powder | 0.21 |
| Black pepper | 0.11 |
| Salt | 0.63 |
| Lemon juice | 0.84 |
| Brown sugar | 4.38 |
| Yellow mustard | 0.16 |
| Hickory smoke | 0.42 |
| Ketchup spice | 0.03 |
| ClearJel | 2.60 |
| I + G | 0.68 |
| Worcestershire sauce | 5.16; |
| Water | 60.04 |
| Vinegar (200 grain) | 2.30 |
| Tomato paste | 7.60 |
| Malt | 6.80 |
| Honey | 3.20 |
| Chili powder | 0.35 |
| Paprika | 0.33 |
| Onion powder | 0.22 |
| Black pepper | 0.12 |
| Salt | 0.70 |
| Chipotle powder | 0.05 |
| Ketchup spice | 0.05 |
| Lemon juice | 0.92 |
| Brown sugar | 4.60 |
| Yellow mustard | 0.16 |
| Hickory smoke | 0.40 |
| ClearJel | 3.20 |
| I + G | 0.60 |
| Habanero puree | 3.25 |
| Worcestershire sauce | 5.10; |
| Water | 59.54 |
| Vinegar (200 grain) | 2.20 |
| Tomato paste | 7.80 |
| Malt | 7.00 |
| Honey | 3.30 |
| Chili powder | 0.40 |
| Paprika | 0.33 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 5.00 |
| Yellow mustard | 0.16 |
| Hickory smoke | 0.50 |
| ClearJel | 3.30 |
| I + G | 0.70 |
| Habanero puree | 2.25 |
| Worcestershire sauce | 5.40; |
| Water | 56.56 |
| Vinegar (200 grain) | 2.09 |
| Tomato paste | 7.41 |
| Malt | 6.65 |
| Honey | 3.14 |
| Chili powder | 0.38 |
| Paprika | 0.31 |
| Onion powder | 0.26 |
| Black pepper | 0.11 |
| Salt | 0.66 |
| Chipotle powder | 0.05 |
| Ketchup spice | 0.05 |
| Lemon juice | 0.87 |
| Brown sugar | 4.75 |
| Yellow mustard | 0.15 |
| Hickory smoke | 0.48 |
| ClearJel | 3.14 |
| I + G | 0.66 |
| Habanero puree | 2.14 |
| Worcestershire sauce | 5.13 |
| Prune paste | 2.50 |
| Black bean paste | 2.50 |
| Garlic powder | 0.05; |
| Water | 53.048 |
| Vinegar (200 grain) | 1.20 |
| Tomato paste | 7.83 |
| Malt | 7.02 |
| Honey | 3.24 |
| Chili powder | 0.38 |
| Paprika | 0.32 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 4.86 |
| Yellow mustard | 0.16 |
| Hickory smoke | 0.49 |
| ClearJel | 3.24 |
| Water for starch solutin | 10.00 |
| I + G | 0.70 |
| Worcestershire sauce | 5.40; |
| Water | 53.05 |
| Vinegar (200 grain) | 1.50 |
| Tomato paste | 7.73 |
| Malt | 7.12 |
| Honey | 3.04 |
| Chili powder | 0.38 |
| Paprika | 0.37 |
| Onion powder | 0.27 |
| Black pepper | 0.12 |
| Salt | 0.70 |
| Chipotle powder | 0.05 |
| Ketchup spice | 0.05 |
| Lemon juice | 0.97 |
| Brown sugar | 4.86 |
| Yellow mustard | 0.16 |
| Hickory smoke | 0.49 |
| ClearJel | 3.24 |
| Water for starch solutin | 10.00 |
| I + G | 0.70 |
| Worcestershire sauce | 5.40; |
| Water | 53.10 |
| Vinegar (200 grain) | 1.41 |
| Tomato paste | 7.73 |
| Malt | 7.02 |
| Honey | 3.24 |
| Chili powder | 0.38 |
| Paprika | 0.32 |
| Onion powder | 0.27 |
| Black pepper | 0.12 |
| Salt | 0.75 |
| Chipotle powder | 0.05 |
| Ketchup spice | 0.05 |
| Lemon juice | 0.92 |
| Brown sugar | 4.70 |
| Yellow mustard | 0.21 |
| Hickory smoke | 0.49 |
| ClearJel | 3.29 |
| Water for starch solutin | 10.00 |
| I + G | 0.65 |
| Worcestershire sauce | 5.30; |
| Water | 62.23 |
| Vinegar (200 grain) | 1.30 |
| Tomato paste | 7.95 |
| Malt | 7.14 |
| Honey | 3.35 |
| Chili powder | 0.38 |
| Paprika | 0.32 |
| Onion powder | 0.27 |
| Black pepper | 0.12 |
| Salt | 0.70 |
| Chipotle powder | 0.11 |
| Lemon juice | 0.92 |
| Brown sugar | 4.80 |
| Yellow mustard | 0.16 |
| Hickory smoke | 0.49 |
| ClearJel | 3.45 |
| I + G | 0.70 |
| Worcestershire sauce | 5.61; |
| Water | 63.23 |
| Vinegar (200 grain) | 1.20 |
| Tomato paste | 7.85 |
| Malt | 7.04 |
| Honey | 3.25 |
| Chili powder | 0.38 |
| Paprika | 0.32 |
| Onion powder | 0.27 |
| Black pepper | 0.12 |
| Salt | 0.70 |
| Chipotle powder | 0.11 |
| Lemon juice | 0.92 |
| Brown sugar | 4.60 |
| Yellow mustard | 0.16 |
| Hickory smoke | 0.49 |
| ClearJel | 3.25 |
| I + G | 0.70 |
| Worcestershire sauce | 5.41; |
| Water | 59.15 |
| Vinegar (200 grain) | 2.06 |
| Tomato paste | 7.46 |
| Malt | 6.69 |
| Honey | 3.09 |
| Chili powder | 0.36 |
| Paprika | 0.30 |
| Onion powder | 0.26 |
| Black pepper | 0.11 |
| Salt | 0.66 |
| Chipotle powder | 0.10 |
| Lemon juice | 0.87 |
| Brown sugar | 4.37 |
| Yellow mustard | 0.15 |
| Hickory smoke | 0.47 |
| ClearJel | 3.09 |
| I + G | 0.67 |
| Worcestershire sauce | 5.14 |
| Prune paste | 2.50 |
| Black bean paste | 2.50 |
| Garlic powder | 0.05; |
| Water | 48.14 |
| Vinegar (200 grain) | 1.20 |
| Tomato paste | 7.80 |
| Malt | 7.00 |
| Honey | 3.30 |
| Chili powder | 0.40 |
| Paprika | 0.33 |
| Onion powder | 0.27 |
| Black pepper | 0.12 |
| Salt | 0.70 |
| Chipotle powder | 0.05 |
| Ketchup spice | 0.05 |
| Lemon juice | 0.92 |
| Brown sugar | 5.00 |
| Yellow mustard | 0.16 |
| Hickory smoke | 0.50 |
| ClearJel | 3.75 |
| Water for starch solution | 10.00 |
| I + G | 0.70 |
| Habanero puree | 4.00 |
| Cayenne pepper 35K | 0.20 |
| Worcestershire sauce | 5.40; |
| Water | 48.26 |
| Vinegar (200 grain) | 1.20 |
| Tomato paste | 7.65 |
| Malt | 7.00 |
| Honey | 3.20 |
| Chili powder | 0.40 |
| Paprika | 0.27 |
| Onion powder | 0.22 |
| Black pepper | 0.12 |
| Salt | 0.65 |
| Chipotle powder | 0.05 |
| Ketchup spice | 0.05 |
| Lemon juice | 0.92 |
| Brown sugar | 4.60 |
| Yellow mustard | 0.16 |
| Hickory smoke | 0.45 |
| ClearJel | 3.70 |
| Water for starch solution | 10.00 |
| I + G | 0.65 |
| Habanero puree | 5.00 |
| Cayenne pepper 35K | 0.25 |
| Worcestershire sauce | 5.20; |
| | and |
| Water | 48.14 |
| Vinegar (200 grain) | 1.20 |
| Tomato paste | 7.80 |
| Malt | 7.00 |
| Honey | 3.20 |
| Chili powder | 0.40 |
| Paprika | 0.33 |
| Onion powder | 0.27 |
| Black pepper | 0.12 |
| Salt | 0.65 |
| Chipotle powder | 0.05 |
| Ketchup spice | 0.05 |
| Lemon juice | 0.92 |
| Brown sugar | 4.90 |
| Yellow mustard | 0.16 |
| Hickory smoke | 0.50 |
| ClearJel | 3.65 |
| Water for starch solution | 10.00 |
| I + G | 0.70 |
| Habanero puree | 4.50 |
| Cayenne pepper 35K | 0.15 |
| Worcestershire sauce | 5.30 |
